(19) United States
(12) Patent Application Publication
(10) Pub. No.: US 2006/0008264 A1
(43) Pub. Date: Jan. 12, 2006

(54) Image taking apparatus

(75) Inventors: Takehisa Yamaguchi, Ikoma-Shi (JP); Shinichi Fujii, Osaka-shi (JP); Takashi Yasuda, Nara-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/173,519

(22) Filed: Jul. 1, 2005

(30) Foreign Application Priority Data
Jul. 6, 2004 (JP) 2004-199512

(51) Int. Cl. G03B 13/34

(52) U.S. Cl. 396/121

(57) ABSTRACT

In an image taking apparatus according to the present invention, focus adjustment is performed based on image information in a focus adjustment area within a captured image in response to a movement instruction from a user as well as a focus adjustment mode switching instruction from the user. When detecting an instruction to switch to a position non-fixed focus adjustment mode, an initial position of the focus adjustment area in the position non-fixed focus adjustment mode immediately after mode switching is determined based on a position of a representative point of the focus adjustment area immediately before the mode switching.

### CROSS-REFERENCE TO RELATED APPLICATON

This application is based on Japanese Patent Application No. 2004-199512 filed in Japan on Jul. 6, 2004, the entire content of which is hereby incorporated by reference.

### BACKGROUND OF THE INVENTION

1. Field of the Invention

The present invention relates to an image taking apparatus having an automatic focusing function.

2. Description of the Related Art

A digital camera has conventionally been known that uses, for focus adjustment, a focus adjustment area fixed in a central part of the captured image. Moreover, a digital camera has been used that is provided with a plurality of focus adjustment modes including a focus adjustment mode in which the position of the focus adjustment area is movable, in order to enable precise focusing on a specific subject.

However, in the conventional digital camera, since the position of the focus adjustment area is fixed immediately after the shift to the focus adjustment mode in which the position of the focus adjustment area is movable, there are cases where the user is forced to largely move the position of the focus adjustment area after the shift to the focus adjustment mode by a manual operation. For this reason, in the conventional digital camera, it is required to reduce the trouble of performing the operation associated with the movement of the position of the focus adjustment area.

### SUMMARY OF THE INVENTION

A main object of the present invention is to provide an image taking apparatus capable of maintaining the continuity of the operation associated with the movement of the position of the focus adjustment area.

Another object of the present invention is to provide an image taking apparatus capable of reducing the trouble of performing the operation associated with the movement of the position of the focus adjustment area.

The above-mentioned objects of the present invention are attained by providing an image taking apparatus having a movement instruction member configured to receive, from a user, an instruction to move a position of a focus adjustment area within a captured image, a switching instruction member configured to receive, from the user, an instruction to switch among a plurality of focus adjustment modes according to the same focus detection method, the plurality of focus adjustment modes including a position non-fixed focus adjustment mode in which the position of the focus adjustment area is moved in response to the movement instruction received by the movement instruction member, and a controller configured to perform focus adjustment based on image information in the focus adjustment area within the captured image in response to the movement instruction from the movement instruction member as well as the focus adjustment mode switching instruction from the switching instruction member, when detecting an instruction to switch to the position non-fixed focus adjustment mode from the switching instruction member, the controller determining an initial position of the focus adjustment area in the position non-fixed focus adjustment mode immediately after mode switching based on a position of a representative point of the focus adjustment area immediately before the mode switching.

These and other objects, advantages and features of the invention will become apparent from the following description thereof taken in conjunction with the accompanying drawings, which illustrate specific embodiments of the invention.

### BRIEF DESCRIPTON OF DRAWINGS

These and other objects, advantages and features of the invention will become apparent from the following description thereof taken in conjunction with the accompanying drawings in which:

FIG. 1 is a front view of a digital camera 1A;

FIG. 2 is a rear view of the digital camera 1A;

FIG. 3 is a block diagram showing the internal structure of a digital camera 1A;

FIG. 4 is a view showing the transition, in the image capturing mode, of the screen displayed on an LCD 180;

FIG. 5 is a view showing an AF area AR1 indicated by a wide focus frame WFF, and sub blocks SB1 to SB11;

FIG. 6 is a view showing an AF area AR2 indicated by a focus frame FF11 (FF1 to FF10);

FIG. 7 is a view showing the screen transition when a shift button 207a and an enter button 200 are simultaneously depressed;

FIG. 8 is a view showing an AF area AR3 indicated by a cursor KR;

FIG. 9 is a view showing the screen transition when the shift button 207a and the enter button 200 are simultaneously depressed;

FIG. 10 is a view showing the position of the AF area when the AF mode is switched from a multi-segment AF mode to an FFP AF mode;

FIG. 11 is a view showing the position of the AF area AR2 when the AF mode is switched from the FFP AF mode to the multi-segment AF mode;

FIG. 12 is a view showing the position of the AF area when the AF mode is switched from a wide AF mode to the FFP AF mode;

FIG. 13 is a view showing the position of the AF area AR2 when the AF mode is switched from the wide AF mode to the multi-segment AF mode;

FIG. 14 is a flowchart explaining an AF mode switching operation;

FIG. 15 is a flowchart explaining the AF mode switching operation; and

FIG. 16 is a flowchart explaining the AF mode switching operation.

### DESCRIPTION OF THE PREFERRED EMBODIMENTS

Hereinafter, an embodiment of the image forming apparatus according to the present invention will be described with reference to the attached drawings.

A digital camera 1A according to the embodiment of the present invention has an AF (automatic focusing) function, and is provided with a plurality of AF modes (focus adjustment modes) associated with AF. These plurality of AF modes include a multi-segment AF mode and an FFP (flex focus point) AF mode in which the position of the AF area (focus adjustment area) within the captured image is movable. In the digital camera 1A, when the AF mode is switched to the multi-segment AF mode or to the FFP AF mode, the position of the AF area immediately after the switching is determined based on the position of the representative point of the AF area immediately before the switching. The structure and operation of the digital camera 1A will be described below. The multi-segment AF mode referred to here is an AF mode in which the AF area can be selected from among preset AF area candidates, and the FFP AF mode referred to here is an AF mode in which the position of the AF area can be more minutely specified than in the multi-segment AF mode.

<External Structure>

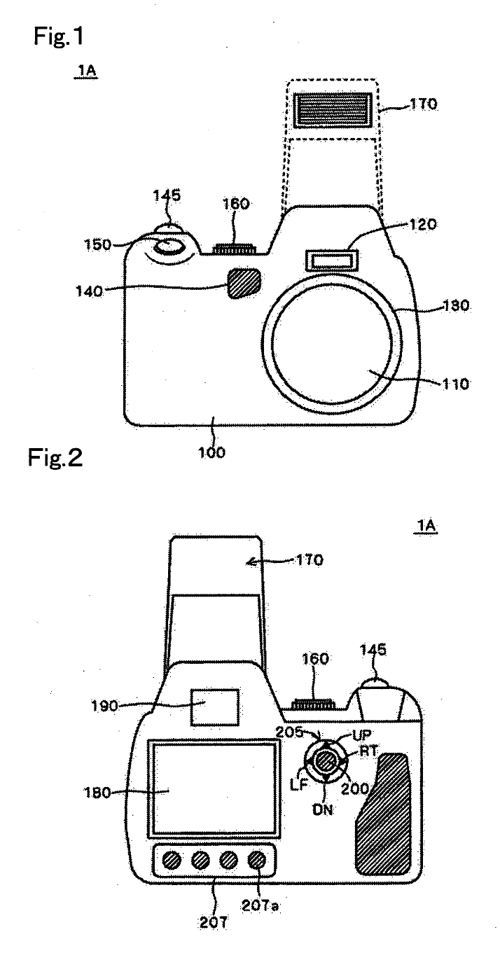

The external structure of the digital camera 1A will be described below with reference to the front view of FIG. 1 and the rear view of FIG. 2.

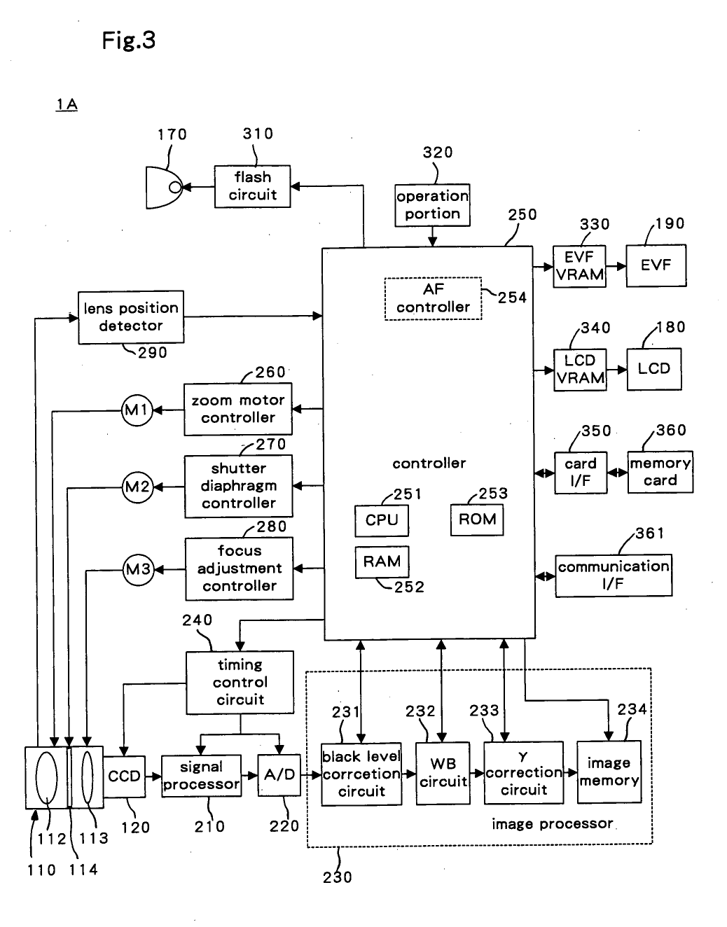

As shown in FIG. 1, a taking lens system 110 is provided on the front surface of a camera body 100 of the digital camera 1A. The taking lens system 110 comprises lens units 112 and 113 held by a lens barrel 130, and a diaphragm 114 (see FIG. 3), and images light incident from the front of the digital camera 1A, on the light receiving surface of a CCD (charge coupled device) 120, (see FIG. 3) which is an image sensor.

Further, an AF fill-in light lamp 140 that applies AF fill-in light to the subject is provided on the front surface of the camera body 100. The AF fill-in light lamp 140 having a light emitting diode as the light source automatically emits light in low light conditions and in low contrast conditions to apply AF fill-in light to the subject.

On the top surface of the camera body 100, the following are provided: an AF mode setting dial 145 for setting the AF mode of the digital camera 1A; a mode setting dial 160 for setting the operation mode of the digital camera 1A; a release button 150 for providing a image capturing start instruction to the digital camera 1A; and a pop-up flash 170 that emits light at the time of fill-flash photography.

The AF mode setting dial 145 is used for switching the AF mode among a wide AF mode, the multi-segment AF mode and the FFP AF mode.

The mode setting dial 160 is a rotary switch for switching the operation mode of the digital camera 1A among a still image capturing mode to perform sill image capturing, a moving image capturing mode to perform moving image capturing and a playback mode to perform playback display of recorded images.

The shutter button 150 is a two-stroke push button switch whose half depressed condition (hereinafter, referred to also as “S1 condition”) and fully depressed condition (hereinafter, referred to also as “S2 condition”) can be determined. The digital camera 1A starts the image capturing preparation operation when detecting that the shutter button 150 is brought into the S1 condition, and starts image capturing for recording when detecting that the shutter button 150 is brought into the S2 condition.

As shown in FIG. 2, an LCD (liquid crystal display) 180 that performs live view display of captured images and playback display of recorded images is provided on the back surface of the camera body 100. An EVF (electronic view finder) 190 for displaying the live view of captured images is provided above the LCD 180.

Further, on the back surface of the camera body 100, a four-way switch 205 having four upper, lower, left and right push buttons UP, DN, LF and RT is provided, and in the center of the four-way switch 205, an enter button 200 is provided. In the image capturing mode, the upper and lower push buttons UP and DN of the four-way switch 205 are used for changing the zoom magnification, and in the playback mode, the left and right push buttons LF and RT of the four-way switch 205 are used for the frame advance of played back images.

The digital camera 1A has an AF area transition mode in which the AF mode can be switched by the AF mode setting dial 145, and the enter button 200 is used for setting the digital camera 1A in the AF area transition mode and for canceling the setting of the AF area transition mode in the digital camera 1A. The four-way switch 205 serves also as an instruction member for providing an instruction to move the AF area to the digital camera 1A in the AF area transition mode.

Below the LCD 180, buttons 207 used for various operations are provided. The buttons 207 include a shift button 207a for changing the function assigned to the button.

<Internal Structure>

Subsequently, the internal structure of the digital camera 1A will be described with reference to the block diagram of FIG. 3.

A controller 250 is a microcomputer having at least a CPU 251, a RAM 252 and a ROM 253, and executes a program stored in the ROM 253 to thereby perform centralized control of components of the digital camera 1A. An AF controller 254 shown in FIG. 3 schematically shows the function associated with AF realized by the controller 250 executing the program.

In the digital camera 1A, AF control (automatic focus adjustment) according to the contrast method is performed by the AF controller 254 in any of the wide AF mode, the multi-segment AF mode and the FFP AF mode. That is, the AF controller 254 calculates the contrast value in the AF area while changing the lens position of the focusing lens unit 113, and moves the focusing lens unit 113 to an in-focus lens position where the contrast value is highest. While the contrast value in the AF area is adopted as the focus evaluation value in the digital camera 1A, the focus evaluation value based on which AF is performed is not limited to the contrast value; it may be a parameter representative of the in-focus degree, for example, the edge width or the number of edges calculated from image information in the AF area. In addition, the AF controller 254 performs the processing to move the AF area in the multi-segment AF mode and the FFP AF mode.

In the lens barrel 130 of the taking lens system 110, the zoom lens unit 112 for changing the zoom magnification (focal length) and the focusing lens unit 113 for performing the focus adjustment of the taking lens system 110 are provided. The zoom lens unit 112 and the focusing lens unit 113 are respectively connected to a zoom motor M1 and a focusing motor M3 for performing driving in the direction of the optical axis. The taking lens system 110 has the diaphragm 114 for changing the quantity of light incident on the CCD 120. The diaphragm 114 is disposed midway between the zoom lens unit 112 and the focusing lens unit 113, and connected to a diaphragm motor M2 for changing the aperture.

Further, the digital camera 1A has a zoom motor controller 260, a shutter diaphragm controller 270 and a focus adjustment controller 280. The zoom motor controller 260, the shutter diaphragm controller 270 and the focus adjustment controller 280 supply driving power to the zoom motor M1, the diaphragm motor M2 and the focusing motor. M3 based on a control signal supplied from the controller 250, respectively. This enables the controller 250 to perform the driving of the zoom lens unit 112 and the focusing lens unit 113 and change the aperture of the diaphragm 114.

A lens position detector 290 comprising an encoder or the like detects the lens positions of the zoom lens unit 112 and the focusing lens unit 113, and outputs the information on the detected lens positions to the controller 250.

The CCD 120 photoelectrically converts the light image formed by the taking lens system 110 into an image signal having color components of R (red), G (green) and B (blue), and outputs it to a signal processor 210. The image signal is a string of pixel signals corresponding to the quantity of light received by the light receiving cells (pixels) constituting the CCD 120.

The signal processor 210 performs predetermined analog signal processings on the image signal inputted from the CCD 120. The signal processor 210 has a CDS (correlated double sampling) circuit and an AGC (automatic gain control) circuit. The CDS circuit reduces the sampling noise of the image signal. The AGC circuit adjusts the level of the image signal. The gain control in the AGC circuit is also used for increasing the level of the image signal when appropriate exposure cannot be obtained by the adjustment of the aperture of the diaphragm 114 and the exposure time of the CCD 120.

An A/D converter 220 converts the analog image signal inputted from the signal processor 210 into-a digital image signal, and outputs it to an image processor 230 as image data.

The CCD 120, the signal processor 210 and the A/D converter 220 operate in synchronism with a reference clock inputted from a timing control circuit 240. The timing control circuit 240 generates the reference clock based on a control signal inputted from the controller 250.

The image processor 230 has a black level correction circuit 231, a WB (white balance) circuit 232, a gamma correction circuit 233 and an image memory 234.

The black level correction circuit 231 corrects the black level of the image data inputted from the A/D converter 220 to a predetermined black level.

The WB circuit 232 performs level conversion of the color components of R, G and B of the image data. The level conversion is performed by use of a level conversion table inputted from the controller 250. The level conversion table is set for each captured image by the controller 250.

The gamma correction circuit 233 converts the gradation of the image data inputted from the WB circuit 232. The gradation conversion is performed based on a predetermined level conversion table.

The image memory 234 temporarily stores the image data inputted from the gamma correction circuit 233. The image memory 234 has a storage capacity capable of storing image data corresponding to one frame.

An operation portion 320 includes the previously-described shutter button 150, mode setting dial 160, AF mode setting dial 145, buttons 207, four-way switch 205 and enter button 200. The controller 250 detects the conditions of these operation members, and makes the detection result reflected in the operation of the digital camera 1A.

A flash circuit 310 supplies power for flash emission to the pop-up flash 170 in response to a flash control signal inputted from the controller 250.

An EVF VRAM 330 and an LCD VRAM 340 have storage capacities capable of storing image data whose numbers of pixels are the same as those of the EVF 190 and the LCD 180, respectively, and serve as the buffer memories of the images displayed on the EVF 190 and the LCD 180.

Moreover, the digital camera 1A has a card I/F (interface) 350 and a communication I/F 361. The card I/F 350 is an interface for writing image data onto a memory card 360 and reading image data from the memory card 360. The memory card 360 is a nonvolatile memory for storing image data of captured images. The communication I/F 361 is an interface for performing communication with an external apparatus connected to the digital camera 1A.

<Basic Operation of the Digital Camera>

During image capturing standby in the image capturing mode, the image signals generated at predetermined time intervals by the CCD 120 are processed by the signal processor 210 to the gamma correction circuit 233, and then, temporarily stored in the image memory 234 as image data. The image data is read out by the controller 250, and converted into pieces of image data whose numbers of pixels are the same as those of the EVF 190 and the LCD 180, respectively. The converted pieces of image data are transferred to the EVF VRAM 330 and the LCD VRAM 340, and the image corresponding to the image data is displayed on the EVF 190 and the LCD 180 as the live view.

In addition, the digital camera 1A adopts so-called continuous AF, and continuously performs AF control based on the image information, in the AF area, of the image after processed by the black level correction circuit 231, also during image capturing standby.

When it is detected that the shutter button 150 is brought into the S1 condition in the image capturing mode, the image signal generated by the CCD 120 is processed by the signal processor 210 to the black level correction circuit 231, and exposure control, AF control and white balance adjustment are performed based on the image information corresponding to the image after the processing. Then, when it is detected that the shutter button 150 is brought into the S2 condition, the image signal generated by the CCD 120 is processed by the signal processor 210 to the gamma correction circuit 233, and then, temporarily stored in the image memory 234 as image data. The image data is read out by the controller 250, undergoes compression processing, tag information addition processing and the like, and then, stored onto the memory card 360 through the card I/F 350.

On the other hand, in the playback mode, the image data stored on the memory card 360 is read out by the controller 250 through the card I/F 350, and undergoes decompression processing. The image data having undergone the decompression processing is converted into pieces of image data whose numbers of pixels are the same as those of the EVF 190 and the LCD 180, and transferred to the EVF VRAM 330 and the LCD VRAM 340. Then, the image corresponding to the image data is played back on the EVF 190 and the LCD 180.

<Screen Transition in the Image Capturing Mode>

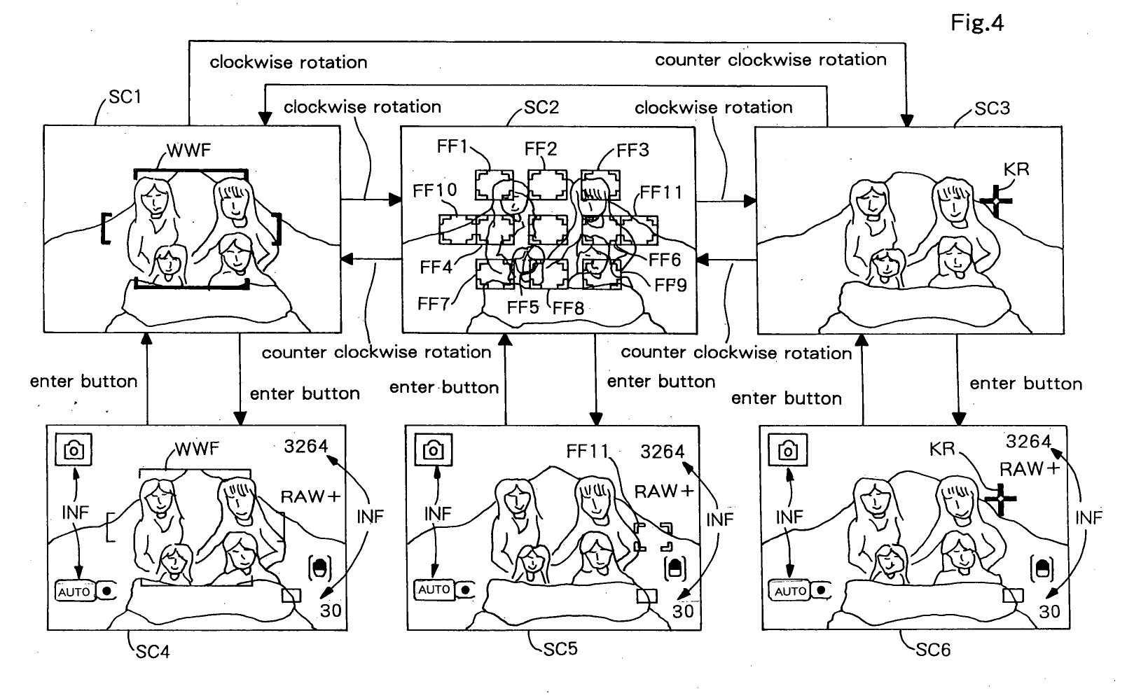

The switching of the AF mode in the image capturing mode and the screen transition that occurs in response thereto will be described below with reference to FIG. 4. FIG. 4 is a view showing the transition, in the image capturing mode, of the screen (hereinafter, also referred to merely as “display screen”) displayed on the LCD 180.

Of the six screens SC1 to SC6 shown in FIG. 4, the screens SC1 to SC3 are display screen examples when the digital camera 1A is set in the AF area transition mode, and the screens SC4 to SC6 are display screen examples when the digital camera 1A is not set in the AF area transition mode. Moreover, of the screens SC1 to SC6, the screens SC1 and SC4, the screens SC2 and SC5 and the screens SC3 and SC6 are display screen examples when the AF mode is the wide AF mode, the multi-segment AF mode and the FFP AF mode, respectively.

When the digital camera 1A is set in the AF area transition mode, the display screen is switched among the screens SC1 to SC3 in response to a rotation in a clockwise direction or a counterclockwise direction (hereinafter, sometimes referred to as “clockwise rotation” and “counterclockwise rotation”) of the AF mode setting dial 145. That is, every time a clockwise rotation is made, the AF mode is circularly switched in the order of the wide AF mode, the multi-segment AF mode and the FFP AF mode, and the display screen is circularly changed in the order of the screen SC, the screen SC2 and the screen SC3. Conversely, every time a counterclockwise rotation is made, the AF mode is circularly switched in the order of the FFP AF mode, the multi-segment AF mode and the wide AF mode, and the display screen is circularly changed in the order of the screen SC3, the screen SC2 and the screen SC1.

When the enter button 200 is depressed under a condition where the digital camera 1A is set in the AF area transition mode, the setting of the AF area transition mode in the digital camera 1A is canceled (the screen SC1→the screen SC4, the screen SC2→the screen SC5, the screen SC3→the screen SC6). When the enter button 200 is depressed under a condition where the digital camera 1A is not set in the AF area transition mode, the digital camera 1A is set in the AF area transition mode (the screen SC4→the screen SC1, the screen SC5→the screen SC2, the screen SC6→the screen SC3). The AF mode is not changed by a depression of the enter button 200.

<Display Screens>

The screens SC1 to SC6 of FIG. 4 will be severally described below.

Wide AF Mode (Screens SC1 and SC4)

On the screen SC1 in the wide AF mode, a wide focus frame WFF indicating a cross-shaped AF area (see FIG. 5) AR1 set within the captured image is displayed so as to be superimposed on the live view. In the wide AF mode, since the position of the AF area AR1 within the captured image is fixed in a central part, the position of the wide focus frame WFF within the screen SC1 is also fixed in the central part. The shape of the AF area AR1 is not limited to a cross shape; it may be, for example, a rectangular.

Since the AF area AR1 occupies a comparatively large area, in the wide AF mode, the subject can be easily included in the AF area AR1. On the other hand, in the wide AF mode, it is difficult to bring a specific subject within the screen SC1 precisely in focus.

As shown in FIG. 5, a plurality of (in this example, eleven) sub blocks SB1 to SB11 are set within the AF area AR1 (see FIG. 5). When the digital camera 1A is set in the wide AF mode, the AF controller 254 identifies, of the sub blocks SB1 to SB11, the sub block including the subject, and performs AF control based on the contrast value in the identified sub block. Further, with the central point (or the point of center of gravity; ditto in the description that follows) of the identified sub block (in this example, the sub block SC10) as the representative point RP1 of the AF area AR1, the AF controller 254 stores the position (coordinates) of the representative point RP1 into the RAM 252. The position stored in the RAM 252 is updated every time the sub block including the subject is changed, so that the information is always the latest. When the AF controller 254 cannot detect the subject and cannot identify the sub block including the subject, the representative point RP1 is the central point C of the AF area AR1.

When a sub block including the subject is present, although the sub block is displayed on the screen SC1, the other sub blocks (in FIG. 5, the sub blocks indicated by the dotted lines) are not displayed on the screen SC1. This sub block display enables the user to recognize the area where AF control is performed within the screen SC1.

The method of identifying the sub block including the subject is not limited, and various known methods may be adopted. For example, a sub block containing a specific color (for example, skin color) in large parts may be set as the sub block including the subject.

On the other hand, on the screen SC4 in the wide AF mode, various pieces of image capturing information INF are displayed in addition to the wide focus frame WFF.

Multi-Segment AF Mode (Screens SC2 and SC5)

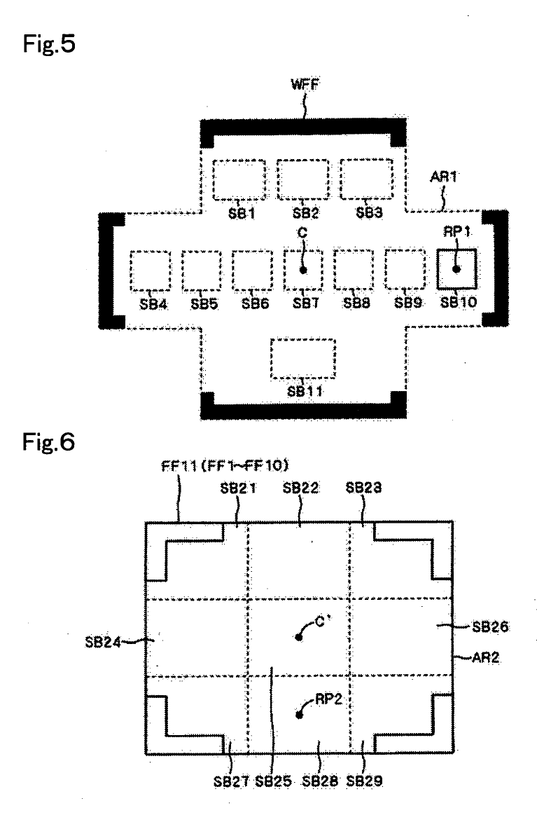

On the screen SC2 in the multi-segment AF mode, eleven focus frames FF1 to FF11 indicating candidates of a rectangular AF area (see FIG. 6) AR2 are displayed so as to be superimposed on the live view. Nine (the focus frames FF1 to FF9) of the focus frames FF1 to FF11 are spaced in a matrix with three rows and three columns. The remaining two (the focus frames FF10 and FF11) of the focus frames FF1 to FF11 are disposed adjacent to the focus frames FF4 and FF6 at both ends of the second row of the matrix. In the multi-segment AF mode, one (in this example, the focus frame FF11) of the focus frames FF1 to FF11 is highlighted, and the AF controller 254 performs AF control based on the contrast value in the AF area AR2 indicated by the highlighted focus frame (hereinafter, sometimes referred to also as “selected focus frame”).

In the multi-segment AF mode, the selected focus frame is not fixed but can be moved vertically and horizontally by an operation of the four-way switch 205. That is, in the multi-segment AF mode, the position of the AF area AR2 can be moved in response to an instruction to change the selected focus frame, that is, an instruction to move the AF area AR2 by the four-way switch 205.

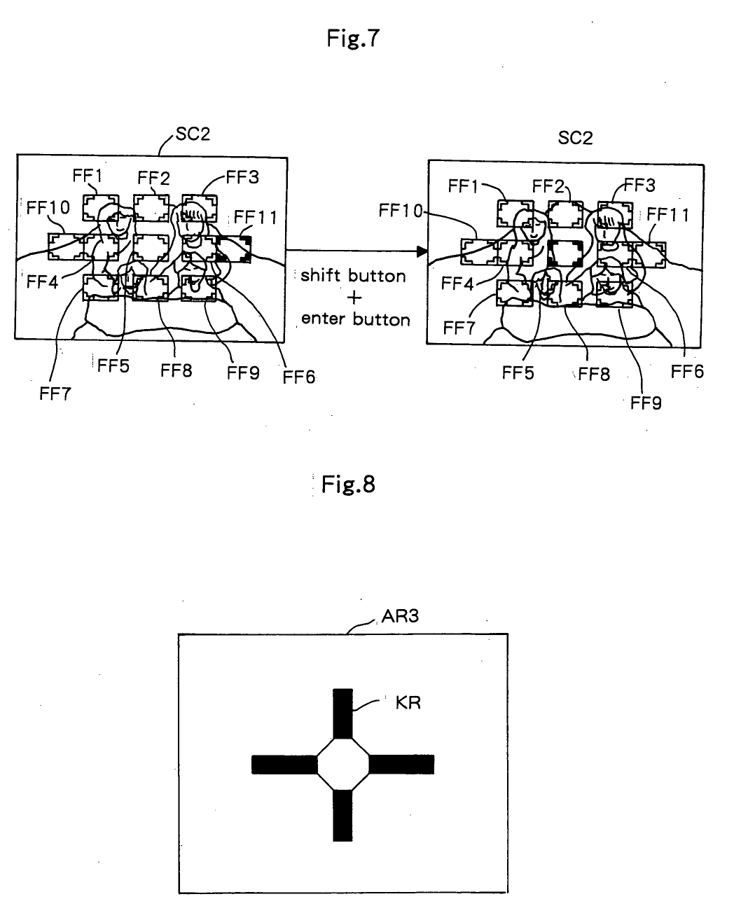

In addition, as shown by the screen transition in FIG. 7, irrespective of which frame is the selected focus frame, the focus frame FF5 in the center of the screen can be set as the selected focus frame by simultaneously depressing the shift button 207a and the enter button 200.

While the size of the AF area AR2 varies also according to the number of pixels of the CCD 120, when the number of pixels of the CCD 120 is several millions, the size is generally selected from among 400×300 pixels to 600×400 pixels. Since this size is set so as to be smaller than the size of the AF area AR1 of the wide AF mode, not only the position of the AF area AR2 can be moved but also in the multi-segment AF mode, it is easier to bring a specific subject precisely in focus than in the wide AF mode.

Moreover, as shown in FIG. 6, a plurality of (in this example, nine) sub blocks SB21 to SB29 not displayed on the screen SC2 are set within the AF area AR2 of the multi-segment AF mode. When performing AF control based on the contrast value in the AF area AR2, the AF controller 254 calculates the contrast value in each sub block, and identifies, as the in-focus point, the central point of the sub block (in this example, the sub block SB28) where the contrast value is the highest, that is, in-focus state is realized in the AF area AR2. Then, with the identified in-focus point as the representative point RP2 of the AF area AR2, the AF controller 254 stores the position (coordinates) of the representative point RP2 into the RAM 252. The position stored in the RAM 252 is updated every time the sub block where in-focus state is realized is changed, so that the information is always the latest. In cases such as a case where the contrast value in the sub block is lower than a predetermined threshold value, it is determined that there is no sub block where in-focus state is realized, and the representative point RP2 is a central point C′ whose relative position with respect to the AF area AR2 is fixed.

On the other hand, on the screen SC5 of the multi-segment AF mode, only the above-mentioned selected focus frame, that is, the focus frame indicating the AF area AR2 actually used for AF control (in this example, the focus frame FF11) is displayed, and the remaining focus frames FF1 to FF10 are not displayed. Moreover, on the screen SC5, image capturing information INF similar to that displayed on the screen SC4 is displayed in addition to the selected focus frame (see FIG. 4).

FFP AF Mode (Screens SC3 and SC6)

On the screen SC3 of the FFP AF mode, a cursor KR indicating a rectangular AF area (see FIG. 8) AR3 is displayed so as to be superimposed on the live view. The cursor-KR is the central point of the AF area AR3. In the FFP AF mode, the AF controller 254 performs focus adjustment based on the contrast value in the AF area AR3 indicated by the cursor KR.

In the FFP AF mode, the position of the cursor KR on the screen SC3 is not fixed but can be moved vertically and horizontally by an operation of the four-way switch 205. That is, in the FFP AF mode, the position of the AF area AR3 can be moved in response to a movement instruction by the four-way switch 205. The resolution (step width) of the position movement of the AF area AR3 of the FFP AF mode is higher than that of the position movement of the AF area AR2 of the multi-segment AF mode. For this reason, in the FFP AF mode, it is easier to bring a specific subject precisely in focus than in the multi-segment AF mode.

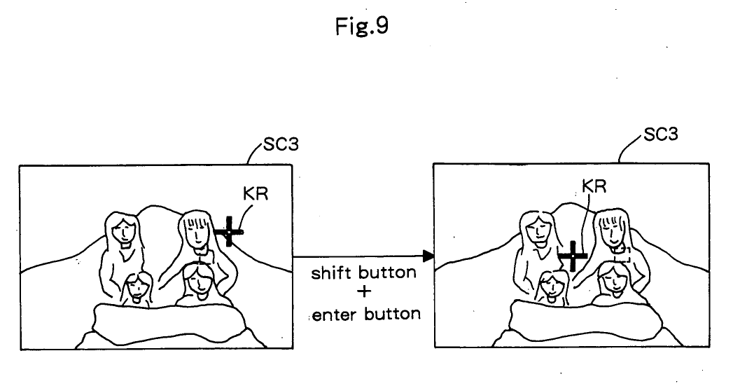

In the FFP AF mode, the cursor KR can be moved to the center of the screen by simultaneously depressing the shift button 207a and the enter button 200 like in the multi-segment AF mode (see FIG. 9).

While the size of the AF area AR3 varies also according to the number of pixels of the CCD 120, when the number of pixels of the CCD 120 is 2000×1500, the size is 250×150 pixels, when the number of pixels of the CCD 120 is 2400×1800, the size is 300×180 pixels, and when the number of pixels of the CCD 120 is 2560×1920, the size is approximately 300×190 pixels. In the FFP AF mode, since focus adjustment is minutely performed, the size of the AF area is set so as to be smaller than that in the multi-segment AF mode within the bounds where a bad influence of camera shake can be avoided.

On the other hand, on the screen SC6 of the FFP AF mode, image capturing information INF similar to that displayed on the screen SC4 is displayed in addition to the cursor KR (see FIG. 4).

<Switching of the AF Mode and the Position of the AF Area Before and After the Switching>

In the digital camera 1A, when the AF mode is switched to the multi-segment AF mode or the FFP AF mode in which the position of the AF area is not fixed by a clockwise or counterclockwise rotation of the AF mode setting dial 145, the position of the AF area immediately after the switching is determined based on the position of the representative point of the AF area immediately before the switching. This determination of the position of the AF area will be described below.

Multi-Segment AF Mode→FFP AF Mode

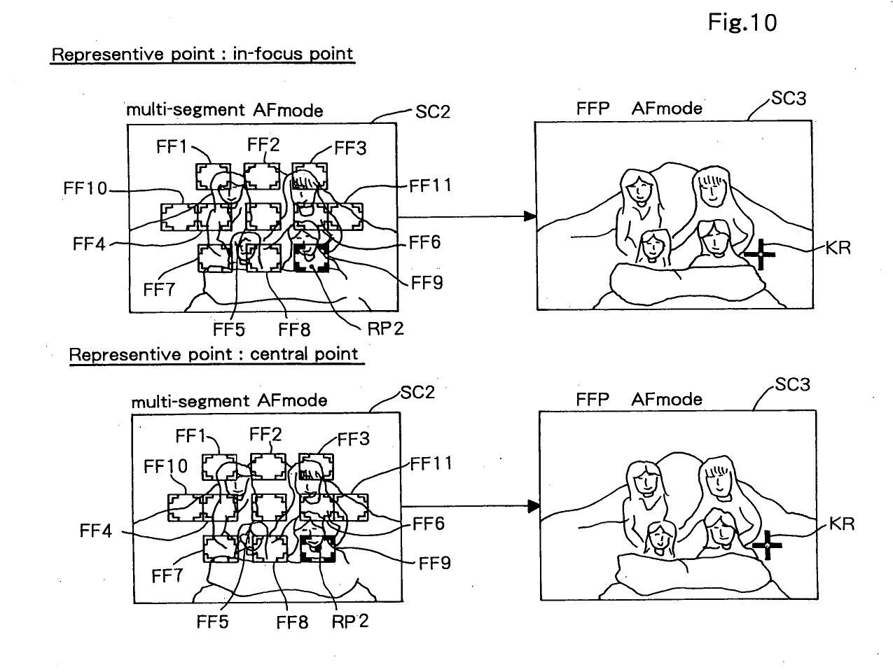

FIG. 10 is a view showing the position of the AF area when the AF mode is switched from the multi-segment AF mode to the FFP AF mode.

The position of the AF area AR3, that is, the position of the cursor KR in the FFP AF mode immediately after the switching is the same as the position of the representative point RP2 of the AF area AR2 (in this example, the AF area indicated by the focus frame FF9) of the multi-segment AF mode immediately before the switching.

The representative point RP2 is the in-focus point or the central point (the point of center of gravity; ditto in the description that follows) of the AF area AR2. While the central point is a fixed point whose relative position with respect to the AF area AR2 is fixed, the relative position of the in-focus point with respect to the AF area AR2 changes as occasion arises. When the in-focus point can be identified, the representative point RP2 is the in-focus point, and when the in-focus point cannot be identified and when an instruction to switch the AF mode is provided before the identification of the in-focus point is completed, the representative point RP2 is the central point.

By thus making the position of the AF area AR3 immediately after the switching to the FFP AF mode the same as the position of the representative point RP2 of the AF area of the multi-segment AF mode immediately before the switching, since the position of the AF area AR3 after the switching is not largely changed from the position of the AR area AR2 before the switching, the continuity of the operation associated with the determination of the position of the AF area is maintained, so that the trouble of performing the operation can be reduced. In particular, when the representative point RP2 is the in-focus point, the position where the subject is highly likely to be present is the position of the AF area AR3, so that the trouble of performing the operation can be further reduced.

FFP AF Mode→Multi-Segment AF Mode

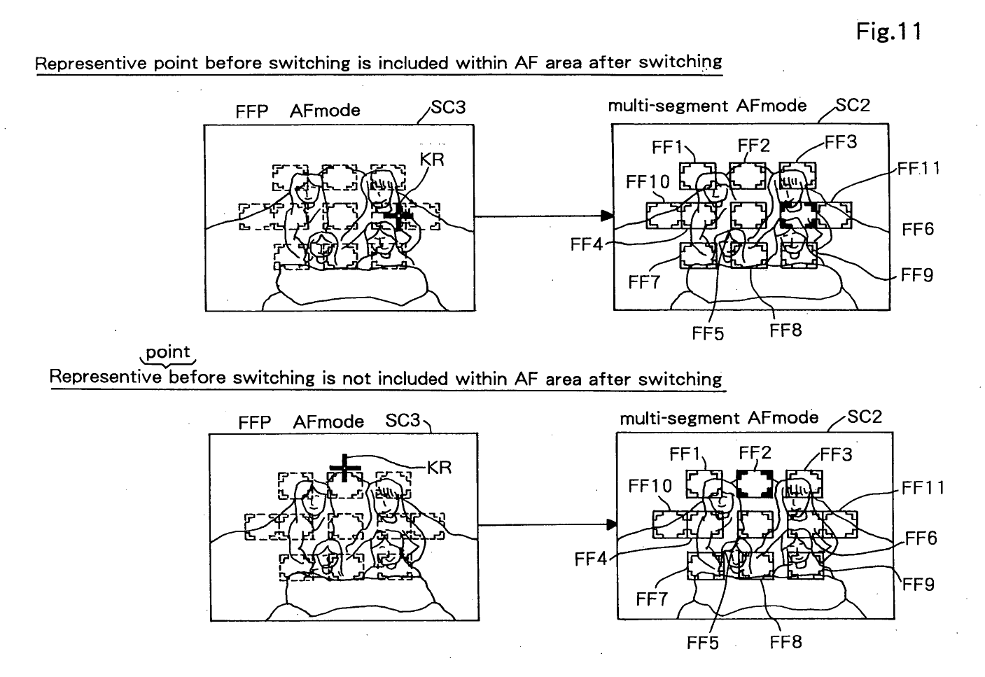

FIG. 11 is a view showing the position of the AF area AR2 when the AF mode is switched from the FFP AF mode to the multi-segment AF mode. In FIG. 11, the focus frames indicated by the dotted lines within the screen SC3 of the FFP AF mode are shown for convenience's sake for ease of understanding, and are not displayed on the actual screen SC3.

The position of the AF area AR2, that is, the position of the selected focus frame in the multi-segment AF mode immediately after the switching is determined based on the position of the representative point of the AF area AR3 of the FFP AF mode immediately before the switching. The representative point is the central point of the AF area AR3, that is, the position of the cursor KR.

More specifically, when the position of the cursor KR immediately before the switching is included within any of the candidates of the AF area AR2 of the multi-segment AF mode immediately after the switching, the candidate of the AF area AR2 including the position of the cursor KR is set as the AF area AR2. On the other hand, when the position is not included, the candidate of the AR area AR2 closest to the position of the cursor KR immediately before the switching is set as the AF area AR2. The distance between the position of the cursor KR and the candidate of the AF area AR2 is the distance between the position of the cursor KR and the central point of the candidate of the AF area AR2.

By thus setting the position of the AF area AR2 immediately after the switching to the multi-segment AF mode to the position closest to the position of the representative point of the AF area AR3 of the FFP AF mode immediately before the switching, since the position of the AF area AR2 after the switching is not largely changed from the position of the AF area AR3 immediately before the switching, the continuity of the operation associated with the determination of the position of the AF area is maintained, so that the trouble of performing the operation can be reduced. In addition, by setting the candidate of the AF area AR2 closest to the position of the representative point as the AF area, even when the position the same as the position of the representative point cannot be set as the position of the AF area, the position of the AF area AR2 after the switching can be prevented from being largely changed from the position of the AF area AR3 before the switching. That is, even when the step width of the position movement of the AF area is large, the continuity of the operation associated with the determination of the position of the AF area can be maintained.

Wide AF Mode→FFP AF Mode

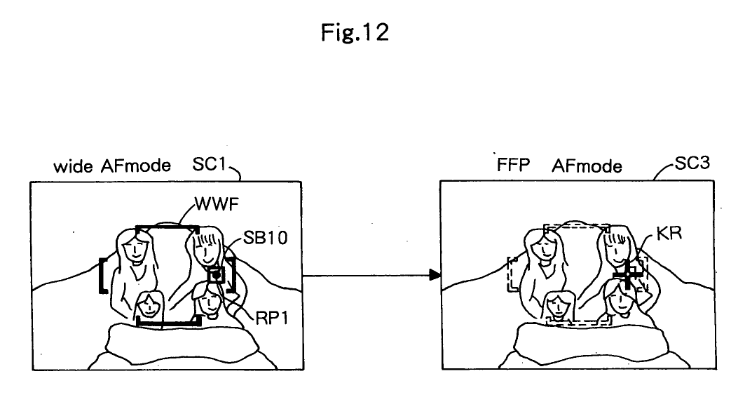

FIG. 12 is a view showing the position of the AF area AR3 when the AF mode is switched from the wide AF mode to the FFP AF mode. The wide focus frame and the sub blocks indicated by the dotted lines within the screen SC3 of the FFP AF mode in FIG. 12 are shown for convenience's sake for ease of understanding, and are not displayed on the actual screen SC3.

The position of the AF area AR3, that is, the position of the cursor KR in the FFP AF mode immediately after the switching is the same as the position of the representative point RP1 of the AF area AR1 of the wide AF mode immediately before the switching. The representative point RP1 is the position of the central point of the sub block including the subject within the AF area AR1.

By thus making the position of the AF area AR3 immediately after the switching to the FFP AF mode the same as the position of the representative point of the AF area of the wide AF mode immediately before the switching, since the position where the subject is highly likely to be present is the position of the AF area AR3, the continuity of the operation associated with the determination of the position of the AF area can be maintained, so that the trouble of performing the operation can be reduced.

Wide AF Mode→Multi-Segment AF Mode

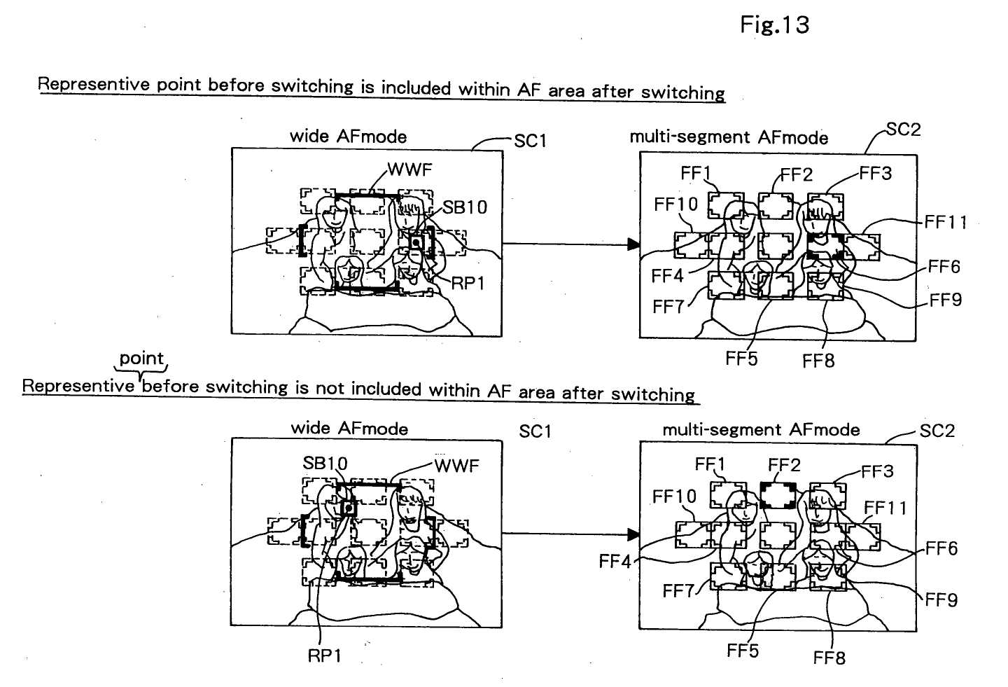

FIG. 13 is a view showing the position of the AF area AR2 when the AF mode is switched from the wide AF mode to the multi-segment AF mode. In FIG. 13, the focus frames indicated by the dotted lines within the screen SC1 of the wide AF mode are shown for convenience's sake for ease of understanding, and are not displayed on the actual screen SC1.

The position of the AF area AR2, that is, the position of the selected focus frame in the multi-segment AF mode immediately after the switching is determined based on the position of the representative point RP1 of the AF area AR1 of the wide AF mode immediately before the switching. The representative point RP1 is the central point of the sub block including the subject.

More specifically, when the position of the representative point RP1 immediately before the switching is included within any of the candidates of the AF area AR2 of the multi-segment AF mode immediately after the switching (the upper row in FIG. 13), the candidate of the AF area AR2 including the position of the representative point RP1 (in this example, the candidate of the AF area AR2 indicated by the focus frame FF6) is set as the AF area AR2. On the other hand, when the position is not included (the lower row in FIG. 13), the candidate of the AR area AR2 closest to the position of the representative point RP1 immediately before the switching is set as the AF area AR2 (in this example, the candidate of the AF area AR2 indicated by the focus frame FF2). The distance between the position of the representative point RP1 and the candidate of the AF area AR2 is the distance between the position of the representative point RP1 and the central point of the candidate of the AF area AR2.

By thus determining the position of the AF area AR2 immediately after the switching to the multi-segment AF mode based on the position of the representative point of the AF area of the wide AF mode immediately before the switching, since the position where the subject is highly likely to be present is the position of the AF area AR2, the continuity of the operation associated with the determination of the position of the AF area can be maintained, so that the trouble of performing the operation can be reduced.

<AF Mode Switching Operation>

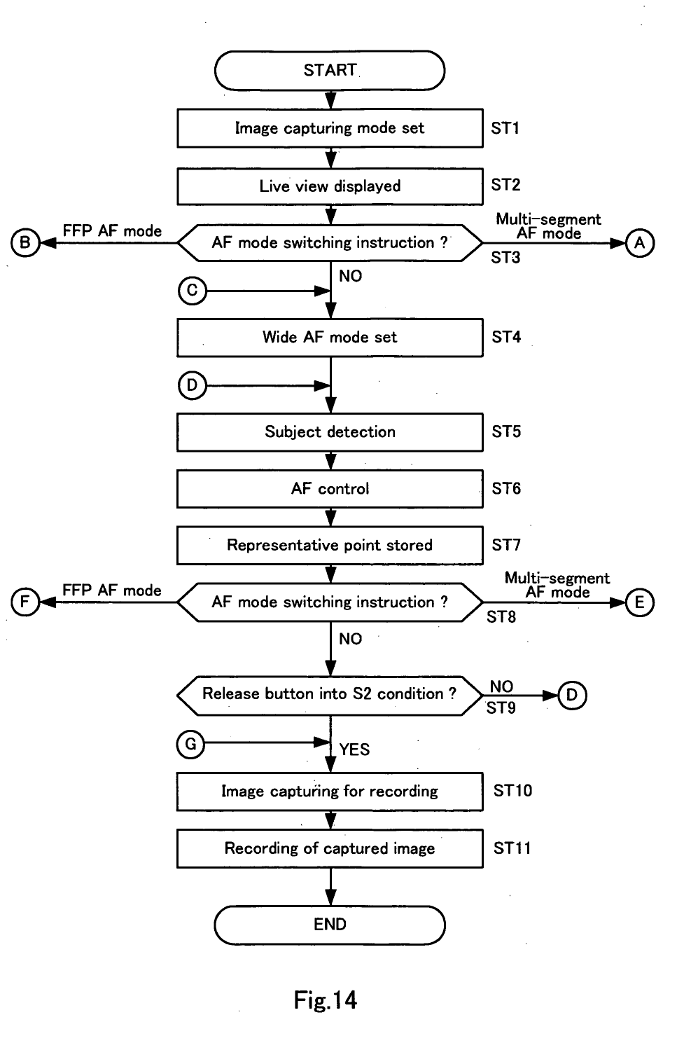

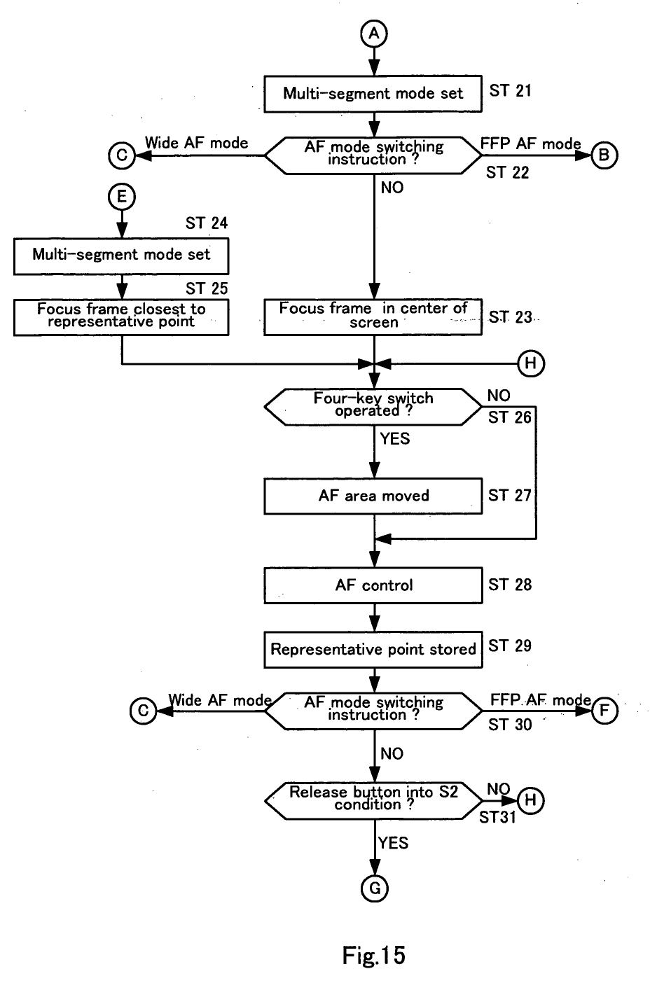

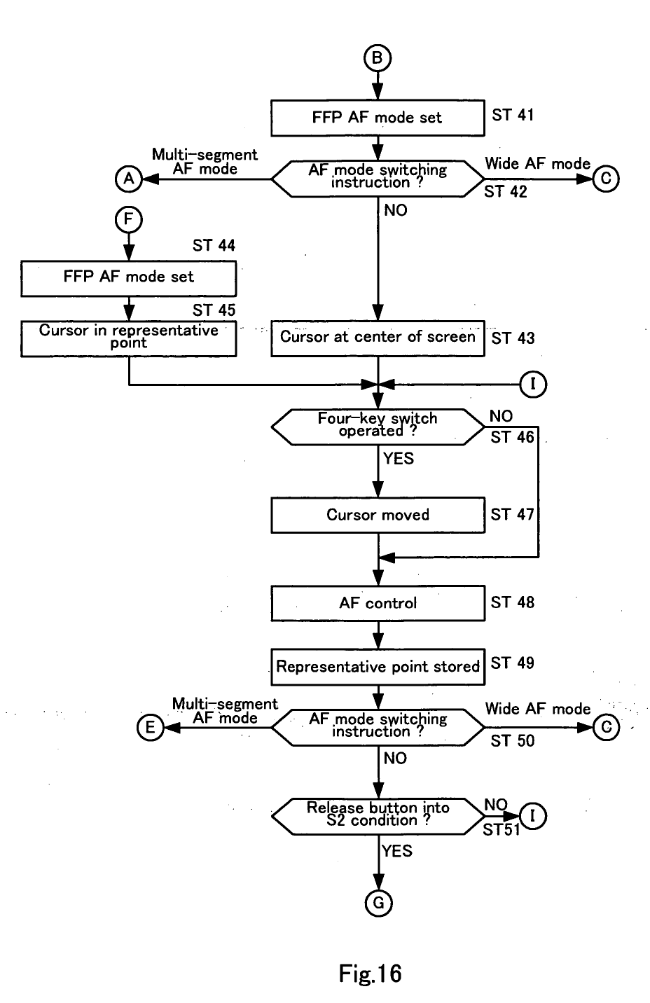

The AF mode switching operation will be described below with reference to the flowcharts of FIGS. 14 to 16. FIGS. 14 to 16 show the operation flows when the power is turned on or the mode setting dial 160 is operated and the operation mode of the digital camera 1A is set in the image capturing mode.

In the operation flows shown in FIGS. 14 to 16, first, the digital camera 1A is set in the image capturing mode [step ST1], and the live view is displayed on the LCD 180 [step ST2]. Then, the digital camera 1A detects the presence or absence of the operation of the AF mode setting dial 145, that is, detects the presence or absence of an AF mode switching instruction [step ST3]. When no AF mode switching instruction is detected at step ST3, the process shifts to step ST4. When an instruction to switch the AF mode to the multi-segment AF mode or to the FFP AF mode is detected, the process shifts to step ST21 or step ST41, respectively. In the stage of step ST3, since the position of the representative point is maintained at the default position (the center of the screen), in the operation flow to which the process shifts, the position of the selected focus frame or the cursor KR is the center of the screen as described later (see step ST23 or ST43).

At step ST4, the AF mode is set to the wide AF mode. Then, the detection of the subject and the identification of the sub block including the subject are performed [step ST5], AF control is performed based on the contrast value in the identified sub block [step ST6], and the position of the central point of the identified sub block is stored in the RAM 252 as the position of the representative point RP1 [step ST7]. Then, the digital camera 1A again detects the presence or absence of the AF mode switching instruction [step ST8]. When no AF mode switching instruction is detected at step ST8, the process shifts to step ST9. When an instruction to switch the AF mode to the multi-segment AF mode or to the FFP AF mode is detected, the process shifts to step ST24 or step ST44, respectively. At step ST8, since the position of the representative point is moved from the default position (the center of the screen), in the operation flow to which the process shifts, the position of the selected focus frame or the cursor is not always the center of the screen as mentioned later.

At step ST9, the condition of the release button 150 is detected. When it is detected that the release button 150 is brought into the S2 condition, image capturing for recording [step ST10] and the recording of the captured image onto the memory card 360 [step ST11] are successively performed. When it is not detected at step ST9 that the release button 150 is brought into the S2 condition, the process returns to step ST5, and the detection of the subject and so forth are repeated.

Steps ST21 to ST31 show the operation flow associated with the operation in the multi-segment AF mode.

At step ST21, the AF mode is set to the multi-segment AF mode, and then, the presence or absence of an AF mode switching instruction is detected [step ST22]. When no AF mode switching instruction is detected at step ST22, the focus frame FF5 in the center of the screen is set as the selected focus frame [step ST23]. When an instruction to switch the AF mode to the FFP AF mode or to the wide AF mode is detected at step ST22, the process shifts to step ST41 or step ST4, respectively. In the stage of step ST22, since the position of the representative point is maintained at the default position (the center of the screen), at the step to which the process shifts, the position of the cursor KR is the center of the screen as described later (see step ST43).

On the other hand, at step ST24, the AF mode is set to the multi-segment AF mode, the focus frame closest to the position of the representative point stored in the RAM 252 is set as the selected focus frame [step ST25]. Since the position of the AF area AR2 indicated by the selected focus frame becomes the position of the representative point of the FFP AF mode (the central point of the AF area AR3=the position of the cursor KR) or the position of the representative point of the wide AF mode (the position of the central point of the sub block including the subject) by step ST25, even if the AF mode is switched, the continuity of the operation associated with the position of the AF area is realized.

At step ST26 following step ST23 or ST25, the presence or absence of an operation of the four-way switch 205, that is, the presence or absence of an AF area movement instruction is detected. When an AF area movement instruction is provided, the AF area is moved in response to the movement instruction [step ST27], and AF control is performed [step ST28]. When no AF area movement instruction is provided, AF control is performed without the AF area AR2 being moved [step ST28]. At step ST29 following step ST28, the position of the in-focus point within the AF area AR2 is stored into the RAM 252 as the position of the representative point RP2, and the presence or absence of an AF mode switching instruction is detected again [step ST30]. At step ST30, since the position of the representative point RP2 is moved from the default position (the center of the screen), in the operation flow to which the process shifts, the position of the focus frame or the cursor is not always the center of the screen as mentioned later. At step ST31, like at step ST9, the condition of the release button 150 is detected. When it is detected that the release button 150 is brought into the S2 condition, the process shifts to image capturing for recording [step ST10]. When it is not detected at step ST9 that the release button 150 is brought into the S2 condition, the process returns to step ST26, and the detection of the operation of the four-way switch and so forth are repeated.

Steps ST41 to ST51 show the operation flow associated with the operation in the FFP AF mode.

At step ST41, the AF mode is set to the FFP AF mode, and then, the presence or absence of an AF mode switching instruction is detected [step ST42]. When no AF mode switching instruction is detected at step ST42, the cursor KR is set at the center of the screen [step ST43]. When an instruction to switch the AF mode to the wide AF mode or to the multi-segment AF mode is detected at step ST42, the process shifts to step ST4 or ST 21, respectively. In the stage of step ST42, since the position of the representative point is maintained at the default position (the center of the screen), in the operation flow to which the process shifts, the position of the selected focus frame is the center of the screen as described later (see step ST23).

On the other hand, at step ST44, the AF mode is set in the FFP AF mode, and the cursor KR is set in the position of the representative point stored in the RAM 252 [step ST45]. Since the position of the AF area AR3 indicated by the cursor KR becomes the position of the representative point of the wide AF mode (the position of the central point of the sub block including the subject) or the position of the in-focus point in the multi-segment AF mode (the position of the central point of the sub block where in-focus state is realized) by step ST45, even if the AF mode is switched, the continuity of the operation associated with the position of the AF area is realized.

At step ST46 following step ST43 or ST45, the presence or absence of an operation of the four-way switch 205, that is, the presence or absence of an AF area movement instruction is detected. When an AF area movement instruction is provided, the cursor KR is moved in response to the movement instruction [step ST47], and AF control is performed [step ST48]. When no AF area movement instruction is provided, AF control is performed without the AF area being moved [step ST48]. At step ST49 following step ST48, the position of the in-focus point within the AF area AR3 is stored into the RAM 252 as the position of the representative point, and the presence or absence of an AF mode switching instruction is detected again [step ST50]. At step ST50, since the position of the representative point is moved from the default position (the center of the screen), in the operation flow to which the process shifts, the position of the selected focus frame is not always the center of the screen as mentioned later. At step ST51, like at step ST9, the condition of the release button 150 is detected. When it is detected that the release button 150 is brought into the S2 condition, the process shifts to image capturing for recording [step ST10]. When it is not detected that the release button 150 is brought into the S2 condition, the process returns to step ST46, and the detection of the operation of the four-way switch and so forth are repeated.

<Modifications>

Regarding Wide AF Mode

While in the above-described embodiment, AF control is performed based on the contrast value in the sub block including the subject in the wide AF mode, it may be performed to perform AF control based on the contrast value in the entire AF area AR1 and use the result of identification of the sub block including the subject only for the determination of the position of the representative point. Moreover, similar to the multi-segment AF mode, it may be performed to identify the in-focus point within the sub block and determine the position of the AF area immediately after the shift to the multi-segment AF mode or to the FFP AF mode, based on the identified in-focus point.

Regarding Continuous AF

While an example in which AF control is continuously performed during image capturing standby is shown in the above-described embodiment, it may be performed to execute AF control only when it is detected that the shutter button 150 is brought into the S1 condition. In this case, a fixed point whose relative position with respect to the AF area is fixed such as the central point of the immediately preceding AF area is set as the representative point.

In the digital camera according to the embodiment of the present invention, since the position of the focus adjustment area immediately after the switching to the position non-fixed focus adjustment mode reflects the position of the representative point of the focus adjustment area immediately before the switching, the continuity of the operation associated with the determination of the position of the focus adjustment area is maintained. Consequently, the trouble of performing the operation can be reduced.

Moreover, in the digital camera according to the embodiment of the present invention, since the position of the focus adjustment area immediately after the switching to the position non-fixed focus adjustment mode reflects the position of the in-focus point within the focus adjustment area immediately before the switching, the position where the subject is highly likely to be present is the position of the focus adjustment area, so that the necessity for the position of the focus adjustment area to be moved immediately after the switching can be reduced. Consequently, the trouble of performing the operation can be further reduced.

Further, in the digital camera according to the embodiment of the present invention, even when the initial position cannot be made the same as the position of the representative point, since the initial position reflects the position of the representative point of the focus adjustment area immediately before the switching, the continuity of the operation associated with the determination of the position of the focus adjustment area can be more reliably maintained. Consequently, the trouble of performing the operation can be further reduced.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. An image taking apparatus comprising:
a movement instruction member configured to receive, from a user, an instruction to move a position of a focus adjustment area within a captured image;
a switching instruction member configured to receive, from the user, an instruction to switch among a plurality of focus adjustment modes according to the same focus detection method, the plurality of focus adjustment modes including a position non-fixed focus adjustment mode in which the position of the focus adjustment area is moved in response to the movement instruction received by the movement instruction member; and
a controller configured to perform focus adjustment based on image information in the focus adjustment area within the captured image in response to the movement instruction from the movement instruction member as well as the focus adjustment mode switching instruction from the switching instruction member, when detecting an instruction to switch to the position non-fixed focus adjustment mode from the switching instruction member, the controller determining an initial position of the focus adjustment area in the position non-fixed focus adjustment mode immediately after mode switching based on a position of a representative point of the focus adjustment area immediately before the mode switching.

2. An image taking apparatus as claimed in claim 1, wherein controller identifies an in-focus point where an in-focus state is realized in the focus adjustment area, and the representative point is the in-focus point identified immediately before the mode switching.

3. An image taking apparatus as claimed in claim 1, wherein the representative point is a point whose relative position with respect to the focus adjustment area is fixed.

4. An image taking apparatus as claimed in claim 1, wherein the initial position of the focus adjustment area in the position non-fixed focus adjustment mode immediately after mode switching is the position of the focus adjustment area which is the closest to the position of the representative point.

5. An image taking apparatus as claimed in claim 1, wherein the initial position of the focus adjustment area in the position non-fixed focus adjustment mode immediately after mode switching is the position of the representative point.

6. An image taking apparatus as claimed in claim 1, wherein the position non-fixed focus adjustment mode includes a first position non-fixed focus detecting mode and a second position non-fixed focus detecting mode, in said first position non-fixed focus detecting mode, the position of the focus adjustment area is changed by selecting of one focus adjustment area from a plurality of predetermined focus adjustment areas in response to the instruction received by the movement instruction member, and in said second position non-fixed focus detecting mode, the position of the focus adjustment area is changed with a higher resolution of the position movement of the focus adjustment area than that of the position movement of the focus adjustment area of the first position non-fixed focus detecting mode.

7. An image taking apparatus as claimed in claim 6, wherein said controller determines the initial position based upon the position of the representative point when the focus adjustment mode is switched from the first position non-fixed focus detecting mode to the second position non-fixed focus detecting mode in response to the instruction received by the switching instruction member.

8. An image taking apparatus as claimed in claim 6, wherein said controller determines the initial position based upon the position of the representative point when the focus adjustment mode is switched from the second position non-fixed focus detecting mode to the first position non-fixed focus detecting mode in response to the instruction received by the switching instruction member.

9. An image taking apparatus as claimed in claim 1, wherein said plurality of focus adjustment modes includes a position fixed focus adjustment mode where the focus adjustment area is fixed, and the controller determines the initial position based upon the position of the representative point when the focus adjustment mode is switched from the position fixed focus adjustment mode to the position non-fixed focus adjustment mode in response to the instruction received by the switching instruction member.

10. A method for performing focus adjustment based upon an image information in a focus adjustment area within a captured image, said method comprising the steps of:
receiving from a user, an instruction to move a position of a focus adjustment area within the captured image;
receiving from a user, an instruction to switch among a plurality of focus adjustment modes according to the same focus detection method, the plurality of focus adjustment modes including a position non-fixed focus adjustment mode in which the position of the focus adjustment area is moved in response to the movement instruction; and
determining an initial position of the focus adjustment area in the position non-fixed focus adjustment mode immediately after mode switching based on a position of a representative point of the focus adjustment area immediately before the mode switching.

11. A method as claimed in claim 10, wherein the representative point is an in-focus point identified immediately before the mode switching, said in-focus point being the point where an in-focus state is realized in the focus adjustment area.

12. A method as claimed in claim 10, wherein the representative point is a point whose relative position with respect to the focus adjustment area is fixed.

13. A method as claimed in claim 10, wherein the initial position of the focus adjustment area in the position non-fixed focus adjustment mode immediately after mode switching is the position of the focus adjustment area which is the closest to the position of the representative point.

14. A method as claimed in claim 10, wherein the initial position of the focus adjustment area in the position non-fixed focus adjustment mode immediately after mode switching is the position of the representative point.

15. A method as claimed in claim 10, wherein the position non-fixed focus adjustment mode includes a first position non-fixed focus detecting mode and a second position non-fixed focus detecting mode, in said first position non-fixed focus detecting mode, the position of the focus adjustment area is changed by selecting of one focus adjustment area from a plurality of predetermined focus adjustment areas in response to the instruction received by the movement instruction member, and in said second position non-fixed focus detecting mode, the position of the focus adjustment area is changed with a higher resolution of the position movement of the focus adjustment area than that of the position movement of the focus adjustment area of the first position non-fixed focus detecting mode.

16. A method as claimed in claim 15 further comprising the step of:
determining the initial position based upon the position of the representative point when the focus adjustment mode is switched from the first position non-fixed focus detecting mode to the second position non-fixed focus detecting mode in response to the switching instruction.

17. A method as claimed in claim 15 further comprising the step of:
determining the initial position based upon the position of the representative point when the focus adjustment mode is switched from the second position non-fixed focus detecting mode to the first position non-fixed focus detecting mode in response to the switching instruction.

18. A method as claimed in claim 10, wherein said plurality of focus adjustment modes includes a position fixed focus adjustment mode where the focus adjustment area is fixed, and further comprising the step of:
determining the initial position based upon the position of the representative point when the focus adjustment mode is switched from the position fixed focus adjustment mode to the position non-fixed focus adjustment mode in response to the switching instruction.

19. A program product which performs focus adjustment based upon an image information in a focus adjustment area within a captured image, said program product being readable by a controller in an image taking apparatus and executing the following steps of:
receiving from a user, an instruction to move a position of a focus adjustment area within the captured image;
receiving from a user, an instruction to switch among a plurality of focus adjustment modes according to the same focus detection method, the plurality of focus adjustment modes including a position non-fixed focus adjustment mode in which the position of the focus adjustment area is moved in response to the movement instruction; and
determining an initial position of the focus adjustment area in the position non-fixed focus adjustment mode immediately after mode switching based on a position of a representative point of the focus adjustment area immediately before the mode switching.
